(19) United States
(12) Patent Application Publication
(10) Pub. No.: US 2016/0052336 A1
(43) Pub. Date: Feb. 25, 2016

(54) Method and Apparatus for Constructing a Floating Wheel Cap

(71) Applicant: Harry Bazerkanian, Covina, CA (US)

(72) Inventor: Harry Bazerkanian, Covina, CA (US)

(21) Appl. No.: 14/932,161

(22) Filed: Nov. 4, 2015

Related U.S. Application Data
(63) Continuation-in-part of application No. 14/028,346, filed on Sep. 16, 2013.

(51) Int. Cl. B60B 7/00; B60B 7/04

(52) U.S. Cl. CPC B60B 7/0053; B60B 7/04; B60B 2310/30; B60B 2310/318; B60B 2320/10; B60B 2310/226; B60B 2900/112

(57) ABSTRACT

Apparatus and method for assembling a floating wheel cap. A bearing is seated into the rear of a passage through an outer disk, against a step, the outer disk offset weighted. A locking ring is fitted into an internal groove in the passage behind the bearing to retain the bearing. The outer disk and the bearing are assembled over a post of an inner disk, the forward end of the post exposed in the front of the assembled outer and inner disks. A second locking ring is fitted to an external groove on the exposed forward end of the post to retain the outer disk on the inner disk. A center ornamental portion cut from an original fixed wheel center cap is cut from the fixed center cap, and attached to the outer disk converting the fixed center cap to a floating center cap.

### CROSS-REFERENCE TO RELATED APPLICATIONS

The present application is a Continuation In Part of U.S. patent application Ser. No. 14/028,346 filed Sep. 16, 2013, which application is incorporated in its entirety herein by reference.

### BACKGROUND OF THE INVENTION

The present invention relates to automotive wheel caps, and more particularly to a method for constructing a floating wheel cap by modifying a fixed wheel cap and attaching a fixed bearing retainer and attaching an offset weight floating cap to a bearing held by the fixed bearing retainer.

Jones, U.S. Pat. No. 710,195 describes an advertising display device adapted to be applied to vehicle-wheels and is supported on the wheel in such manner as to be stationary or non-rotative with respect to the vehicle, whereby the advertising matter displayed on the device will always be in position for proper display and inspection not withstanding the rotation of the wheel.

Tonai, U.S. Pat. No. 2,014,058 describes an invention that related to hub caps and its general object is to provide a hub cap primarily designed for the wheels of motor vehicles, that includes a name plate which is mounted so as to not rotate with the wheel and therefore remains substantially stationary, with the result it not only adds materially to the ornamentality of the wheel, but the name on the plate can be distinguished while the vehicle is in motion.

Gasco, U.S. Pat. No. 2,169,237 describes a stationary ornament for wheel hubcaps in such a manner that the ornament remains in a stationary position while the wheel is rotating by the vehicle traveling in a forward direction. In this type of construction the nameplate is mounted on the wheel or wheel hubcap by a free running or anti-friction bearing of some type.

Ryan, U.S. Pat. No. 2,548,070 describes an improved advertising display device adapted for use on motor vehicles. This invention is comprised of a sign carrying member having imprinted on one side thereof media or indicia, which said member is especially adapted for attachment to a non-rotatable axle of a motor vehicle in rotatably mounted on said axle. It provides an advertising display device for use on motor vehicle of various types, such as trucks, taxicabs, buses or the like.

Lucas, U.S. Pat. No. 2,869,262 describes improvements in wheel-supported advertising signs, and its principal object is to provide a convenient means for attaching an advertising sign to the hub cap of an automobile wheel in such a manner that the advertising sign is held against revolving movement while the wheel rotates, and which presents its advertising material in readable position at all times. This invention provides an anchoring means or adapter for the sign centrally of the hub cap and arranged in such a manner that it takes up little space for accommodation in relatively small tolerances between the cap and an axle extending into the same.

Matsushita, U.S. Pat. No. 4,678,239 describes a hub cap assembly having a non-rotating wheel cover consisting of a disc like body on which indicia, advertising material, trademarks and the like can be placed. The cover body is provided with a weight on its back surface acting to normally maintain the cover in a given orientation and is held on an outer bracket fitted with an annular bearing at its center and radially extending spokes through which the cover body is attached. An annular bearing is located within the annular center of the outer flange and is resiliently attached to the central boss portion of an inner bracket. The inner bracket being provided with a plurality of radial stays having a V-shaped clip at its end adapted to engage with the rim portion of the wheel.

Boothe, U.S. Pat. No. 4,781,4 describes a hub cap locking arrangement, in which, in a first embodiment, a hub cap having a cup-shaped configuration with a generally tubular portion insertable into the wheel hub opening, the tubular portion having a diameter slightly smaller than the diameter of the wheel hub opening of an alloy vehicle wheel. The hub cap may be formed from cast or machined metal or plastic material and is provided with a plurality of radially extending threaded apertures, through which extend pointed threaded members of high strength metal, the threaded members having either a hex head opening or a slotted end.

Levy et al., U.S. Pat. No. 5,190,354 describes a wheel cover for the wheel of a vehicle, comprising a securement and support device secured to the hub or to the rim of the wheel and a substantially flat shield element, mounted on the device for rotation and having an asymmetric spacing of its mass relative to its axis of rotation, permitting the shield element to maintain a fixed angular position relative to the horizontal, even during rotation of the wheel.

Rutterman et al., U.S. Pat. No. 5,490,342 describes a wheel cover for mounting on a wheel rim comprising a base member having a disc member rotatably mounted thereto to display an indicia thereon, the base member and disc member each includes stabilizing structure configured to mate with each other to maintain concentric alignment and restrict oscillation of the disc member relative to the base member and a counterweight attached to the disc member such that as the base member rotates with the wheel rim. The disc member does not rotate relative to the vehicle so that the indicia on the disc member can be viewed as the vehicle translates over the supporting surface.

Harlen, U.S. Pat. No. 5,588,715 describes a non-rotatable wheel cover assembly including a mounting assembly for mounting the wheel cover directly to a wheel-supporting member of a vehicle. The wheel cover has inner and outer surfaces and the wheel-supporting member is disposed for supporting wheels of the vehicle during rotation thereof. The mounting assembly includes a first attaching element mounted on the inner surface of the wheel cover and a wheel cover support assembly for secured relation of the first attaching element and the wheel supporting member. The wheel cover support assembly is disposed for non-rotational support of the first attaching element and the wheel cover during rotation of the wheel.

Boothe et. al, U.S. Pat. No. 5,957,542, disclosed a non-rotating wheel cover attached using a mounting base held inside a wheel by three radially extending screws. Access to the screws requires removing the wheel from the vehicle, thus providing an anti-theft feature. However, the non-rotating wheel cover of the '542 patent requires several machined parts and is somewhat expensive to manufacture, and is sized to individual wheels.

The prior art thus teaches a variety of weighted wheel covers for the purpose of fixed orientation during wheel rotation. However, the prior art does not teach a method for constructing an inexpensive floating cap suitable for various wheel sizes.

### BRIEF SUMMARY OF THE INVENTION

The present invention addresses the above and other needs by providing an apparatus and method for assembling a floating wheel cap. A bearing is seated into the rear of a passage through a front portion, against a step, the front portion offset weighted. A locking ring is fitted into an internal groove in the passage behind the bearing to retain the bearing. The front portion and the bearing are assembled over a post of a rear portion, the forward end of the post exposed in the front of the assembled front and rear portions. A second locking ring is fitted to an external groove on the exposed forward end of the post to retain the front portion on the rear portion. A center ornamental portion of an original fixed wheel center cap is cut from the fixed center cap, and attached to the front portion converting the fixed center cap to a floating center cap.

In accordance with one aspect of the invention, there is provided a method for assembling a floating center cap, the method including: obtaining an outer disk having a passage through the outer disk, a step in the passage near an outer passage end, and an outward facing face; obtaining in inner disk having a closed back surface, an inner disk post centered on the closed back face and extending out from the closed back face, a cylindrical wall extending out from a periphery of the close back surface defining a recessed volume, and features outside the wall configured to attach the inner disk to a wheel inside a wheel center; inserting a bearing, into the passage through the outer disk, and against a fixed step in the passage; seating an inside retaining ring in the passage behind the bearing to retain the bearing in the passage against the passage bearing seat; sliding the outer disk over the inner disk post and against a second step; seating an outside retaining ring over the post to retain the outer disk on the inner disk; obtaining an ornamental disk; and attaching an ornamental disk to the face of the outer disk.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a front view of a prior art vehicle wheel and tire.

FIG. 2 is a cross-sectional view of a prior art vehicle wheel and tire taken along line 2-2 of FIG. 1.

FIG. 3A is a front view of a prior art wheel cap.

FIG. 3B is a rear view of the prior art wheel cap.

FIG. 4 is a cross-sectional view of the prior art wheel cap taken along line 4-4 of FIG. 3A.

FIG. 5 is an exploded cross-sectional view of a floating wheel cap according to the present invention.

FIG. 6 is an assembled view of the floating wheel cap according to the present invention.

FIG. 7 shows a detailed view of an outer disk of the floating wheel cap according to the present invention.

FIG. 8 shows a detailed view of an inner disk of the floating wheel cap according to the present invention.

FIG. 9 shows a second embodiment of the inner disk according to the present invention.

FIG. 10 shows a third embodiment of the inner disk according to the present invention.

FIG. 11 is an exploded cross-sectional view of a second floating wheel cap according to the present invention.

FIG. 12 is an assembled view of the second floating wheel cap according to the present invention.

FIG. 13 shows a first method for constructing the floater cap assembly according to the present invention.

FIG. 14 shows a second method for constructing the floater cap assembly according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

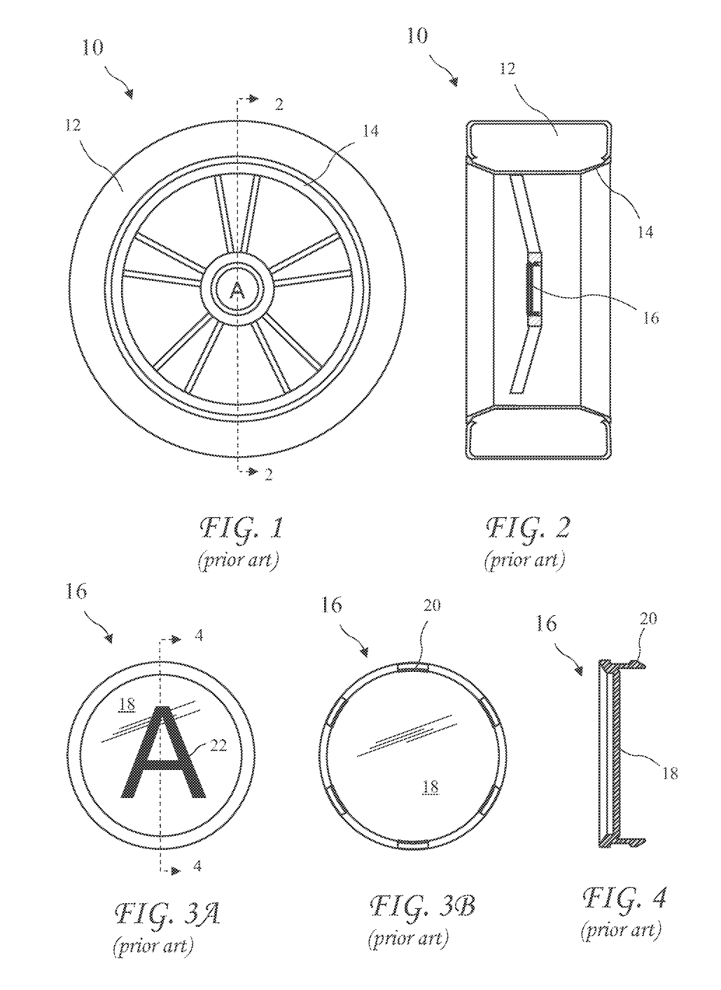

A front view of a prior art vehicle wheel 14 and tire 12 assembly 10 is shown in FIG. 1 and a cross-sectional view of a prior art vehicle wheel and tire taken assembly 10 along line 2-2 of FIG. 1 is shown in FIG. 2. The wheel 14 includes a prior art ornamental removable wheel cap 16 residing in the center of the wheel 14.

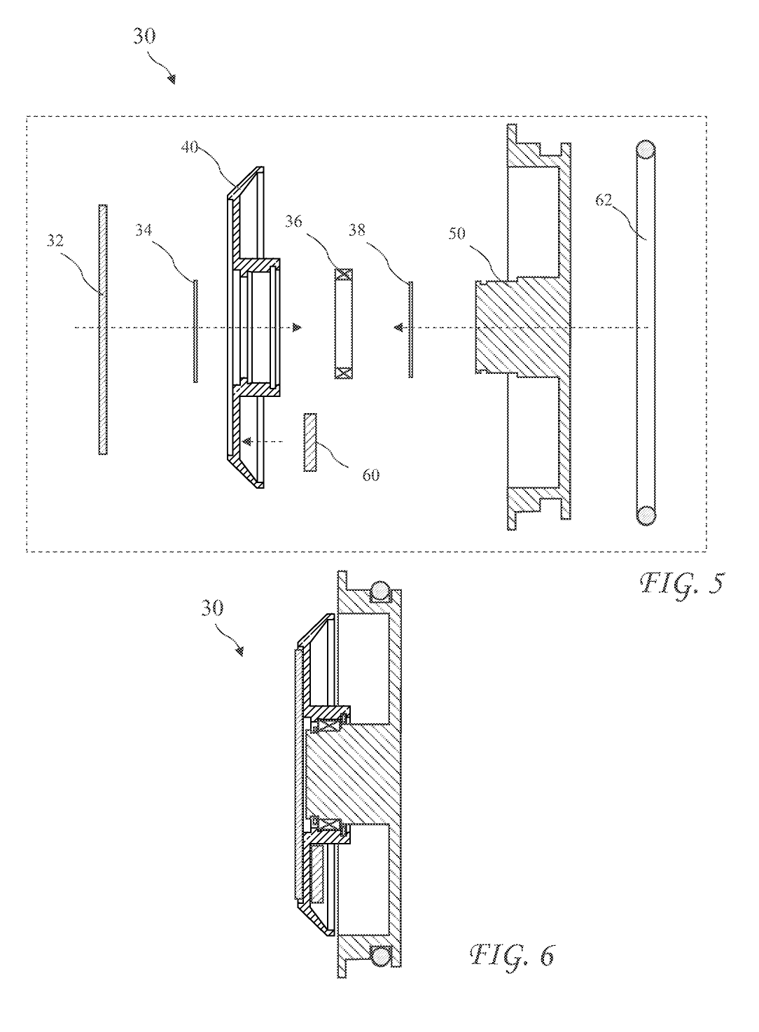

A front view of the original wheel cap 16 is shown in FIG. 3A, a rear view of the original wheel cap 16 is shown in FIG. 3B, and a cross-sectional view of the wheel cap 16 taken along line 4-4 of FIG. 3A is shown in FIG. 4. The original wheel cap 16 includes a face 18 which may include an ornamental design 22, for example, a design associated with the vehicle the wheel is used on, or a manufacturer of custom wheels. The original wheel cap 16 further includes attaching features for attaching the original wheel cap 16 to the wheel 14. The attaching features may be tabs 20 angularly spaced apart around the perimeter of the original wheel cap 16 allowing the original wheel cap 16 to snap into the wheel 14, and allowing removal of the original wheel cap 16 from the wheel 14. In some instances, the face 18 may include a passage for attaching a fixed emblem.

An exploded cross-sectional view of a floating wheel cap 30 according to the present invention is shown in FIG. 5 and an assembled view of the floating wheel cap is shown in FIG. 6. The floating wheel cap 30 includes an ornamental disk 32, an outside locking ring 34, an outer disk 40, a bearing 36, an inside locking ring 38, an inner disk 50, a weight 60, and an O-Ring 62. The floating wheel cap 30 is assembled as described in FIG. 11

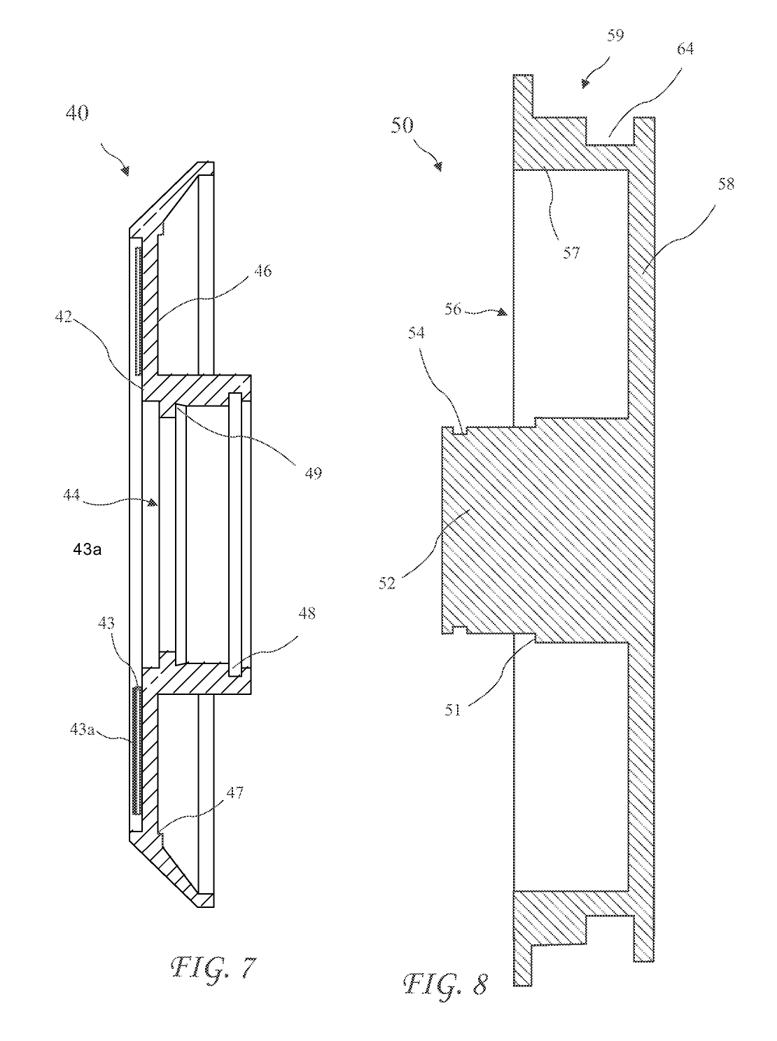

A detailed view of the outer disk 40 is shown in FIG. 7. The outer disk 40 includes a face 42, a layer of tape 43 on the face 42, the layer of tape 43 having an adhesive on an outer surface and preferably a removable release layer 43a over the adhesive, a through passage 44, a back surface 46, a weight positioning step 47, an inside ring retaining groove 48, and a forward bearing step 49. While the step 49 is shown to retain a bearing inserted into the passage 44 from the rear, the step 49 may also be forward facing and near the rearward end of the passage 44, the inside ring retaining groove 48 may be near the forward end of the passage 44, and the bearing may be inserted from the forward end of the passage 44.

FIG. 8 shows a detailed view of an inner disk 50 of the floating wheel cap 30. The inner disk 50 includes an outward reaching post 52 an outside ring retaining groove 54, a volume 56, a cylindrical wall 57, a back 58, and attaching features outside the cylindrical wall 57. A step 51 on the post 52 positions the bearing 36 on the post 52.

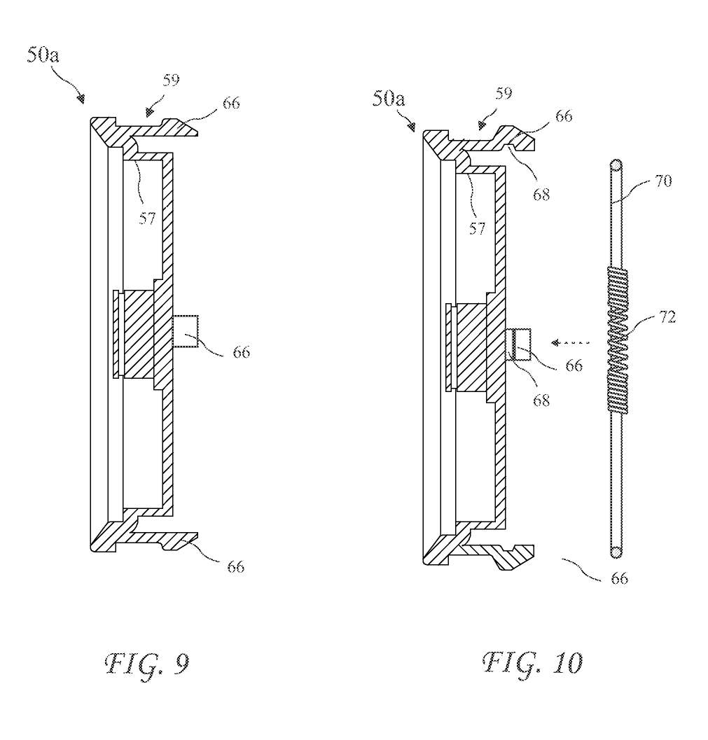

A second embodiment of the inner disk 50a is shown in FIG. 9. The inner disk 59a includes at least three finger 66 and preferably six fingers 66, to engage a wheel to retain the floating wheel cap 30.

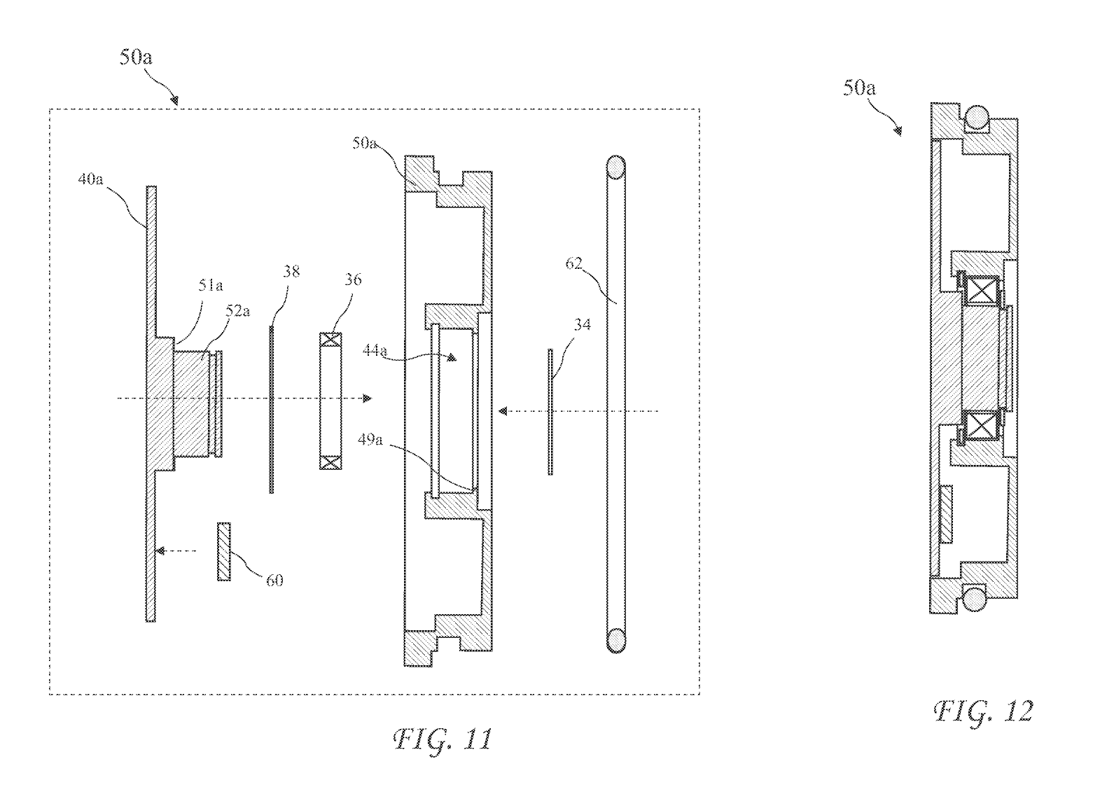

A third embodiment of the inner disk 50b is shown in FIG. 10. The inner disk 59b includes the fingers 66 to engage a wheel to retain the floating wheel cap 30, and each finger 66 includes an inside notch 68 which receive an expanding ring 70. The expander ring 70 includes a spring 72 to maintain radial force on the fingers 66.

An exploded cross-sectional view of a second floating wheel cap 50a is shown in FIG. 11 and an assembled view of the second floating wheel cap 50a is shown in FIG. 12. The floating cap 50a is assembled from a second outer disk 40a, an inside locking ring 38, a bearing 36, a second inside disk 50a, an outside locking ring 34, and O-ring 62, and a weight 60. The assembly of the floating wheel cap 50a is described in FIG. 14. The second floating cap 50a includes steps 49a in the passage 44a, and 51a on the post 52a, for positioning the bearing 36 in the inner disk 50a, and for positioning the outer disk 40a in the bearing 36.

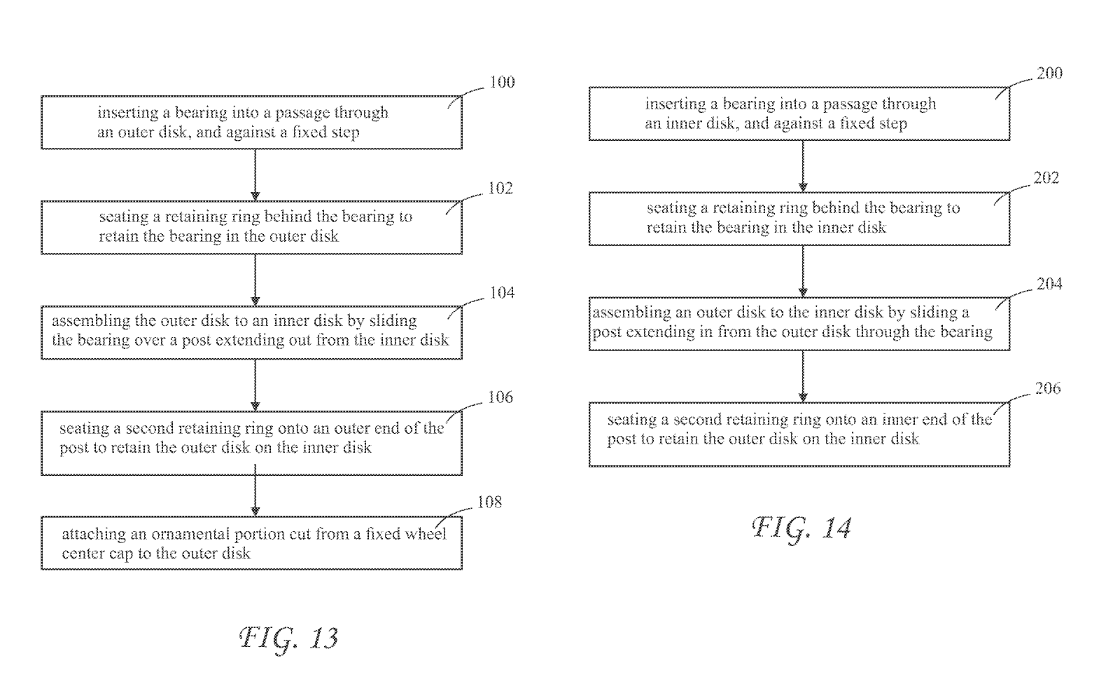

FIG. 13 shows a method for constructing the floater cap assembly. The method includes: inserting a bearing, into a passage through an outer disk, and against a fixed step at step 100; seating a retaining ring behind the bearing to retain the bearing in the outer disk at step 102; assembling the outer disk to an inner disk by sliding the bearing over a post extending out from the inner disk at step 104; seating a second retaining ring onto an outer end of the post to retain the outer disk on the inner disk at step 106; and attaching an ornamental portion cut from a fixed wheel center cap to the outer disk at step 108.

The bearing may be inserted into the passage from the front or rear, and is preferably inserted from the rear.

FIG. 14 shows a method for constructing the second floater cap assembly 50a. The method includes: inserting a bearing into a passage through an inner disk, and against a fixed step at step 200; seating a retaining ring behind the bearing to retain the bearing in the inner disk at step 202; assembling an outer disk to the inner disk by sliding a post extending in from the outer disk through the bearing at step 204; seating a second retaining ring onto an inner end of the post to retain the outer disk on the inner disk at step 206

While the invention herein disclosed has been described by means of specific embodiments and applications thereof, numerous modifications and variations could be made thereto by those skilled in the art without departing from the scope of the invention set forth in the claims.

I claim:

1. A method for constructing a floating wheel cap, the method comprising:
obtaining an outer disk having:
a passage through the outer disk;
an outer passage stop in the passage; and
an outward facing face;
obtaining an inner disk having:
a closed back;
an inner disk post centered on the closed back face and extending out from the closed back face;
a cylindrical wall extending out from a periphery of the close back surface defining a recessed volume; and
attaching features outside the wall configured to attach the inner disk to a wheel;
inserting a bearing, into the passage through the outer disk, and against the outer passage stop in the passage;
seating an inside retaining ring in the passage behind the bearing to retain the bearing in the passage against the passage bearing seat;
sliding the outer disk over the inner disk post;
seating an outside retaining ring over the post to retain the outer disk on the inner disk;
obtaining an ornamental disk; and
attaching an ornamental disk to the face of the outer disk.

2. The method of claim 1, wherein obtaining an ornamental disk comprises cutting an ornamental portion of a fixed center cap from a retaining portion to obtain the ornamental disk.

3. The method of claim 1, wherein the outer disk includes an adhesive tape residing on the face of the outer disk attaching the ornamental disk to the face of the outer disk

4. The method of claim 3, wherein:
the adhesive tape is covered by a release layer; and
attaching the ornamental disk to the face of the outer disk includes first removing the release layer to expose the adhesive.

5. The method of claim 1, wherein obtaining an outer disk further includes obtaining an offset weighted outer disk.

6. The method of claim 5, wherein:
the outer disk includes an inward facing flat surface; and
obtaining an offset weighted outer disk comprises attaching a weight to the inward facing flat surface of the outer disk.

7. The method of claim 6, wherein:
the inward facing flat surface of the outer disk includes a weight positioning step; and
attaching the weight to the inward facing flat surface of the outer disk includes positioning the weight against the positioning step.

8. The method of claim 1, wherein the outer passage stop is a step inside the passage.

9. The method of claim 8, wherein the outer passage stop is a step inside the passage

9. The method of claim 1, wherein sliding the outer disk over the inner disk post includes sliding the bearing against a second step on the inner disk post.

10. A method for constructing a floating wheel cap, the method comprising:
obtaining an outer disk having:
a passage through the outer disk;
an outer passage stop in the passage near an outer passage forward end; and
an outward facing face;
obtaining an inner disk having:
a closed back;
an inner disk post centered on the closed back face and extending out from the closed back face;
a cylindrical wall extending out from a periphery of the close back surface defining a recessed volume; and
attaching features outside the wall configured to attach the inner disk to a wheel;
inserting a bearing, from the rear, into the passage through the outer disk, and against the outer passage stop in the passage;
seating an inside retaining ring in the passage behind the bearing to retain the bearing in the passage against the passage bearing seat;
sliding the outer disk over the inner disk post;
seating an outside retaining ring over the post to retain the outer disk on the inner disk;
obtaining an ornamental disk; and
attaching an ornamental disk to the face of the outer disk.

11. A method for constructing a floating wheel cap, the method comprising:
obtaining an outer disk having:
a passage through the outer disk;
an outer passage stop in the passage near an outer passage rearward end; and
an outward facing face;
obtaining an inner disk having:
a closed back;
an inner disk post centered on the closed back face and extending out from the closed back face;
a cylindrical wall extending out from a periphery of the close back surface defining a recessed volume; and
attaching features outside the wall configured to attach the inner disk to a wheel;
inserting a bearing, from the front, into the passage through the outer disk, and against the outer passage stop in the passage;
seating an inside retaining ring in the passage behind the bearing to retain the bearing in the passage against the passage bearing seat;
sliding the outer disk over the inner disk post;
seating an outside retaining ring over the post to retain the outer disk on the inner disk;
obtaining an ornamental disk; and
attaching an ornamental disk to the face of the outer disk.
